(19) United States
(12) Patent Application Publication
(10) Pub. No.: US 2026/0338215 A1
(43) Pub. Date: Oct. 29, 2026

(54) Temporary Fastener of Structures

(71) Applicant: LISI AEROSPACE, Paris (FR)

(72) Inventor: Julien BRACHET, Mehun sur Yèvre (FR)

(73) Assignee: LISI AEROSPACE, Paris (FR)

(21) Appl. No.: 19/645,445

(22) Filed: Apr. 13, 2026

(30) Foreign Application Priority Data
Apr. 23, 2025 (FR) 2504308

(51) Int. Cl. F16B 19/10; F16B 5/06

(52) U.S. Cl. CPC F16B 19/109; F16B 5/0607

(57) ABSTRACT

The invention relates to a fastener (10) for the temporary assembly of at least two pre-perforated structures, comprising: a tubular main body (14); a tubular clamp body (16), that move along an axis relative to the main body; a front portion (44) of the clamp body comprising a set of radial openings (50); a spreader (22), extending into the main body and into the clamp body; and an actuating element (24), positioned at the rear end of the main body and rotatable relative to the main body. By rotating the actuating element, the clamp body and space can move along an axis relative to each other. The fastener also comprises a set of clamp elements (18) and an annular spring component (20), positioned in the front portion (44) of the clamp body, the annular spring component surrounding the clamp elements.

This invention relates to a fastener for the temporary assembly of at least two previously perforated structures, comprising: a tubular main body, extending along an axis between a front end and a rear end; a tubular clamp body, that can move axially relative to the main body and comprising a front portion and a rear portion, aligned along the axis; the rear portion being blocked against rotation within the main body; the front portion forming a projection beyond the front end of the main body and comprising: a radial surface, substantially circular-cylindrical; and several radial openings, positioned around the axis; a spreader, extending along the axis within the main body and the clamp body; and an actuating element, positioned at the rear end of the main body and rotatable relative to the main body; the fastener is configured such that, under the effect of a rotation of the actuating element relative to the main body, the clamp body and the spreader are movable relative to each other between a first and a second axial position of the spreader relative to the clamp body.

The invention relates specifically to temporary fasteners of the insertable clamp type.

In the aeronautical industry, before performing the final assembly of two structural elements, it is common practice to carry out a temporary assembly of the elements using temporary fasteners inserted into the through-holes. Such temporary fasteners are, in particular, described in document EP3781825 in the name of LISI Aerospace.

Typically, such temporary fasteners include flexible clamps, each with a hooking spur at one end. When a robot is used to remove a temporary fastener from structural elements, the removal may not occur in a direction exactly perpendicular to the elements' surface. There is a risk that the spurs will catch on the rear surface, preventing removal of the temporary fastener.

The aim of the invention is then to offer a fastener as described above, enabling the temporary fastener to be removed without hooking the rear face, even if the direction of removal is not exactly perpendicular to the elements' surface.

To this end, the object of the invention is a fastener of the aforementioned type, also comprising several clamp elements and an annular spring component, positioned in the front portion of the clamp body, the annular spring component surrounding the clamp elements; each clamp element facing one of the several radial openings of the clamp body; each clamp element comprising a bearing surface, substantially perpendicular to the axis and oriented towards the rear portion of the clamp body; and wherein: each clamp element is movable relative to the clamp body, between a retracted position, in which the clamp element is entirely contained within the radial surface of the front portion, and a deployed position, in which the clamp element is positioned in the corresponding radial opening and the support surface of the clamp element projects radially relative to the radial surface of the front portion; under the effect of mechanical stress, the annular spring component is reversibly stretchable between a first and a second transverse dimension; and the fastener is movable between: a retracted configuration, in which the spreader is in the first axial position relative to the clamp body, each clamp element is in the retracted position and the annular spring component has the first transverse dimension; and a deployed configuration, in which the spreader is in the second axial position relative to the clamp body, the clamp elements surround the spreader, each clamp element is in the deployed position and the annular spring component has the second transverse dimension.

The annular spring component returns the clamp elements back into the clamp body as soon as the spreader reaches the corresponding axial position. The fastener can then be easily separated from the structures.

Other advantageous aspects of the invention are that the fastener comprises one or more of the following features, taken individually or according to all technically possible combinations:
the spreader comprises a first and a second part, aligned along the axis and having respectively a first and a second radial dimension, the first radial dimension being smaller than the second radial dimension; the fastener being configured so that, in the retracted configuration and in the deployed configuration of the fastener, the clamp elements are positioned respectively around the first part and around the second part of the spreader;
each clamp element comprises a radial outer surface with a groove portion, substantially perpendicular to the axis; and the annular spring component is positioned in the groove portion of each of the clamp elements;
each clamp element is bound angularly by two sides; and in the retracted configuration, the adjacent sides of two adjacent clamp elements are in contact with each other;
the fastener comprises two clamp elements, wherein: the clamp body comprises two radial openings and two tabs separating the radial openings; each tab comprises an internal flat spot, parallel to the axis; each clamp element comprises two external flat spots, parallel to each other and to the axis; and in the deployed configuration of the fastener, each of the external flat spots of each clamp element is in contact with the internal flat spot of one of the two tabs;
the spreader is fixed axially with respect to the main body; the actuating element comprises a threaded inner surface; and the rear portion of the clamp body comprises a thread, able to cooperate with the threaded inner surface, so that rotation of the actuating element with respect to the main body leads to axial displacement of the clamp body with respect to the main body;
the fastener also comprises a retaining element positioned in the main body and fixed relative to it, with the spreader integral with the retaining element;
the rear portion of the clamp body and the retaining element respectively comprise first and second flat surfaces, parallel to the axis; the first and second flat surfaces are adapted to slide against each other during axial displacement of the clamp body relative to the main body;
the spreader is integral with the actuating element; the actuating element comprises a threaded outer surface; and the rear portion of the clamp body comprises a tapping, able to cooperate with the threaded outer surface, so that rotation of the actuating element relative to the main body leads to axial displacement of the clamp body relative to the main body;
the rear portion of the clamp body and an internal surface of the main body comprise third and fourth flat surfaces respectively, parallel to the axis; the third and fourth flat surfaces are able to slide against each other during axial displacement of the clamp body relative to the main body;
the main body comprises a bearing wall designed to bear against a first face of the structures.

The invention also relates to an assembly comprising: structures to be assembled, comprising first and second opposite faces, as well as a hole opening on each of first and second faces; and a fastener as described above, in deployed configuration, the front portion of the clamp body being positioned in the hole, the bearing wall of the main body and the bearing surface of the clamp elements being in contact, respectively, with the first and second faces of the structures.

The invention will become clearer upon reading the following description, which is provided solely as a non-limiting example, and with reference to the drawings, in which:

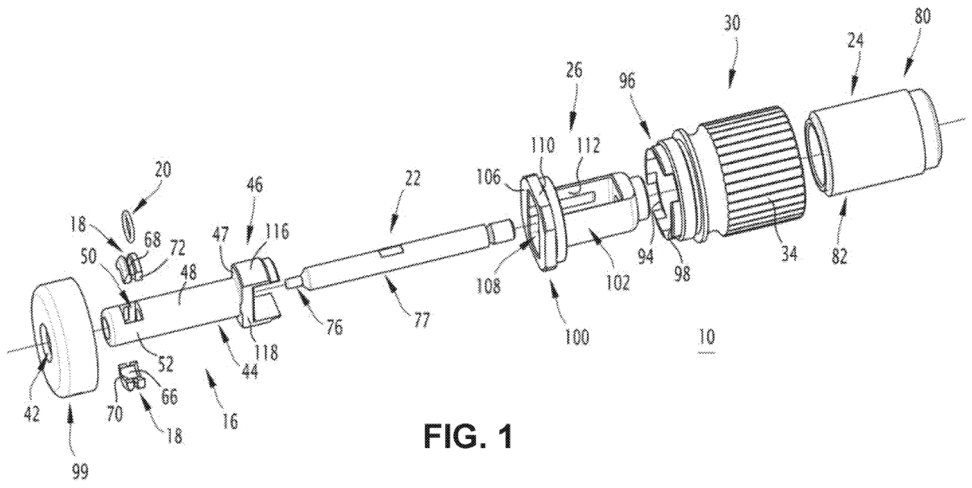

FIG. 1 is an exploded view of a fastener according to a first embodiment of the invention;

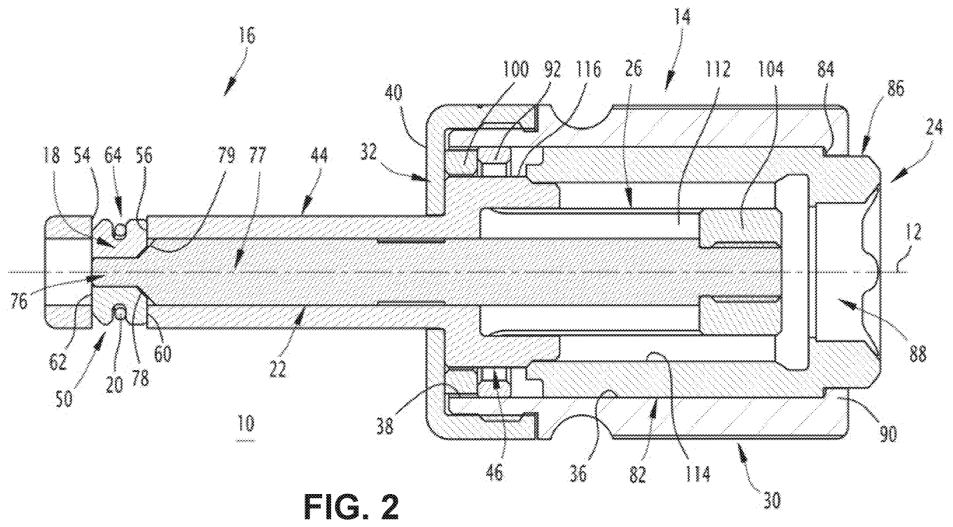

FIG. 2 is a cross-section view of the fastener in FIG. 1, in the first configuration;

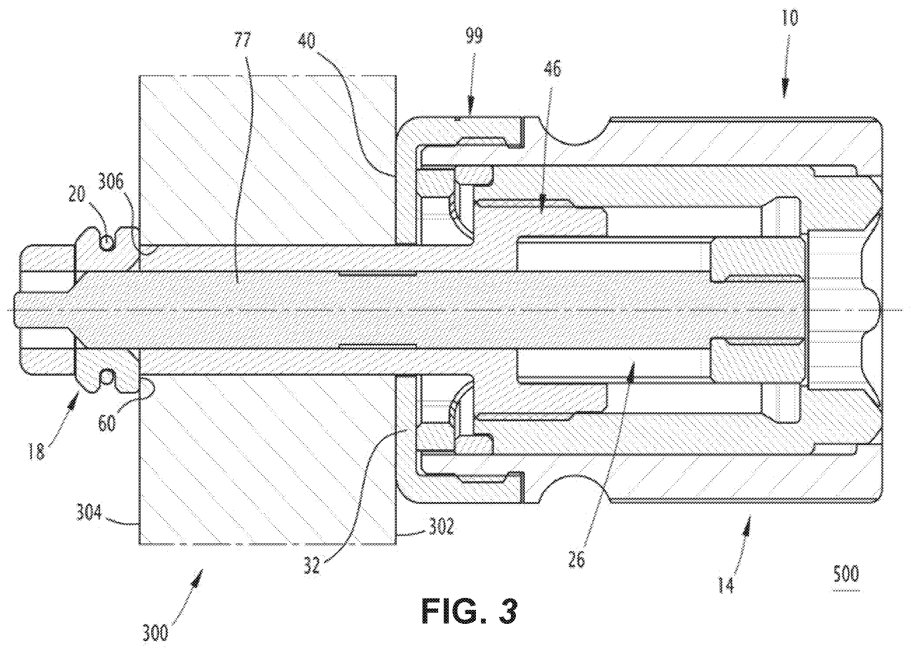

FIG. 3 is a cross-section view of an assembly comprising the fastener in FIG. 1 in a second configuration;

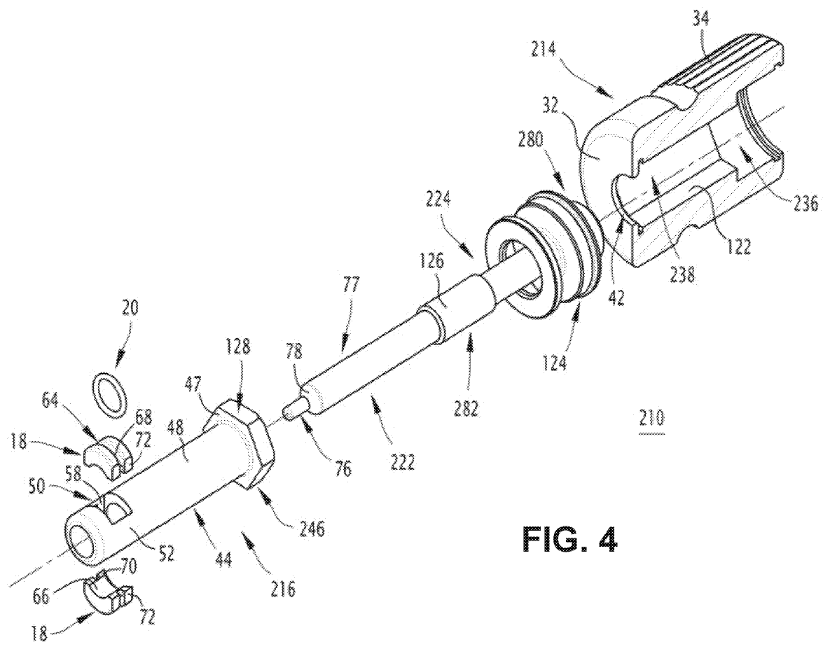

FIG. 4 is an exploded view, in partial cross-section, of a fastener according to a second embodiment of the invention;

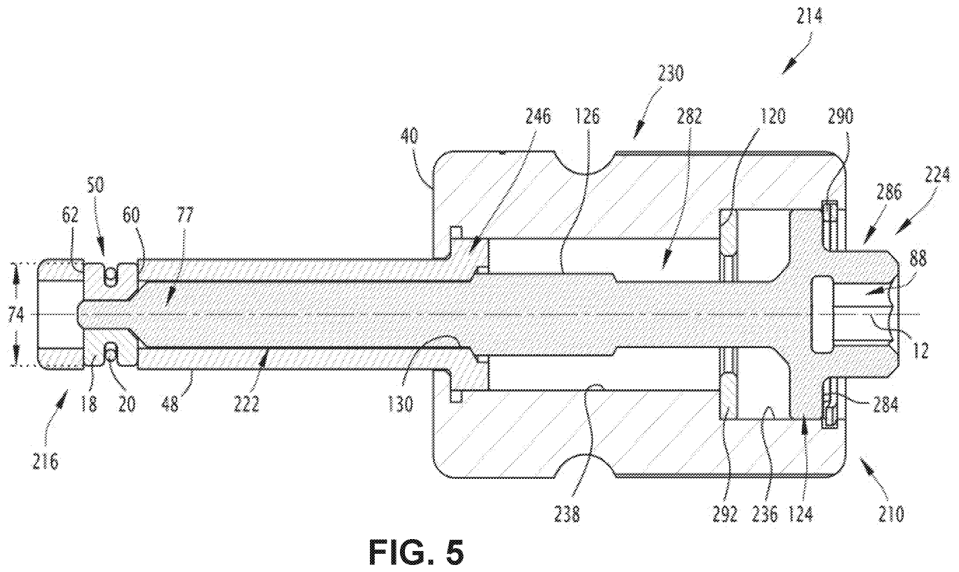

FIG. 5 is a cross-sectional view of the fastener in FIG. 4, in the first configuration; and

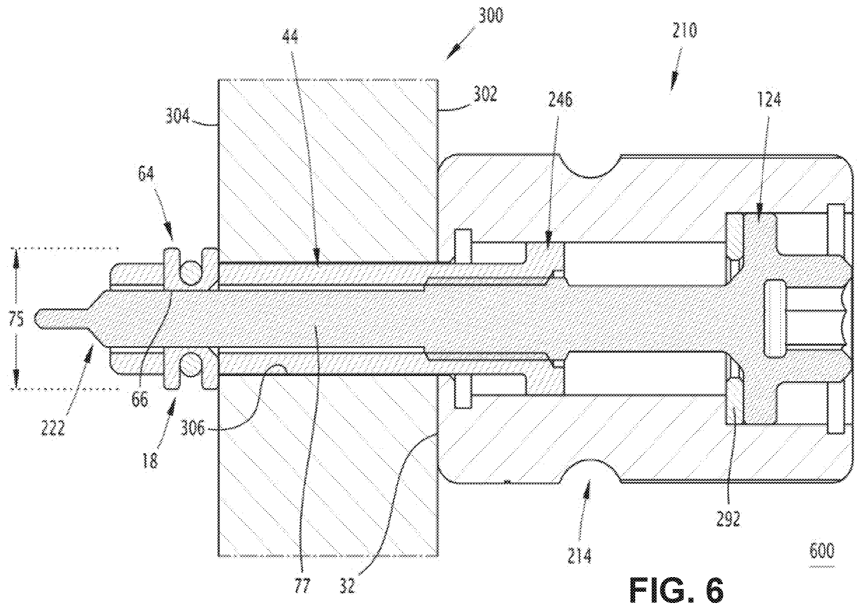

FIG. 6 is a cross-section view of an assembly comprising the fastener of FIG. 2 in a second configuration.

FIGS. 1 to 3 show a fastener 10 according to a first embodiment of the invention. FIGS. 4 to 6 show a fastener 210 according to a second embodiment of the invention.

Fasteners 10 and 210 will be described simultaneously hereinafter, the common elements being designated by the same reference numbers.

Fastener 10, 210 is suitable for temporarily joining at least two pre-perforated structures 300. More precisely, FIG. 3 shows an assembly 500 according to a first embodiment of the invention, comprising the fastener 10 and the structures 300; and FIG. 6 shows an assembly 600 according to a second embodiment of the invention, comprising the fastener 210 and the structures 300. For the sake of simplicity, the structures 300 are shown as a single unit.

The fastener 10, 210 extends along an axis 12 and comprises: a main body 14, 214; a clamp body 16, 216; several clamp elements 18; an annular spring component 20; a spreader 22, 222; and an actuating element 24, 224. In the first embodiment, the fastener 10 also comprises a retaining element 26.

In the embodiments shown, the main body 14, 214 is formed of a tubular portion 30, 230 and a bearing wall 32. The tubular part 30, 230 extends along axis 12 between a first and a second open end, the bearing wall 32 being positioned at the first end of the tubular part 30, 230.

In the remainder of the description, it is assumed that the bearing wall 32 is positioned at the front end of the main body 14, 214 along axis 12, and that the second end of the tubular part 30, 230 forms a rear end of the main body 14, 214. More generally, in the remainder of the description, the terms “front” and “rear” are understood to mean the direction with respect to the axis 12 of the fastener 10, 210.

The tubular part 30, 230 has an outer surface and an inner surface, extending around axis 12. In the embodiments shown, the outer surface of the tubular part 30, 230 has rotation-blocking systems 34, such as teeth.

The inner surface of tubular part 30, 230 comprises the rear and front inner surfaces 36, 236 and 38, 238 of the main body 14, 214, aligned along axis 12. The front inner surface 38, 238 has an anti-rotation form, as will be explained below. In the embodiments shown, the rear inner surface 36, 236 is circular-cylindrical.

The bearing wall 32 is substantially perpendicular to axis 12 and comprises: a front face 40; and a central opening 42, formed in the bearing wall around axis 12.

The clamp body 16, 216 has a tubular shape and extends along axis 12. The clamp body comprises a front portion 44 and a rear portion 46, 246, axially adjacent and integral with each other, preferably formed in a single piece.

Perpendicular to axis 12, the rear portion 46, 246 has a maximum outer dimension greater than a maximum external dimension of the front portion 44. Preferably, the front 44 and rear 46, 246 portions of the clamp body 16, 216 are connected by a flat shoulder 47, perpendicular to axis 12.

The clamp body 16, 216 projects axially from the main body 14, 214. In the embodiments shown, the clamp body 16, 216 passes through the central opening 42 of the bearing wall 32, so that the front portion 44 projects forward from the bearing wall 32. Preferably, shoulder 47 abuts axially against a rear face of bearing wall 32.

The front portion 44 of the clamp body 16, 216 comprises: an external radial surface 48, cylindrical in shape; and a set of radial openings 50, formed in the radial surface 48. More precisely, the front portion 44 comprises a set of tabs 52, partially forming the radial surface 48, each tab 52 separating two angularly adjacent radial openings 50. Preferably, the radial openings 50 are evenly distributed at regular angular intervals around axis 12.

Each radial opening 50 extends axially between two closed ends, formed by a front edge 54 and a rear edge 56. Preferably, the front edges 54 of the radial openings 50 are flat, coplanar, and perpendicular to the axis 12; and similarly, the rear edges 56 of the radial openings are flat, coplanar, and perpendicular to the axis 12.

According to a first variant not shown, each of the front and rear edges is formed by a plane forming an acute angle with axis 12. According to a second variant not shown, each of the front and rear edges is formed by at least two planes: for example, a plane perpendicular to axis 12 and a plane forming an acute angle, such as a chamfer.

In the embodiments shown, the front portion 44 has two radial openings 50, symmetrical to each other with respect to axis 12, and two tabs 52, symmetrical to each other with respect to axis 12. In a variant not shown, the front portion has a number of radial openings greater than or equal to three, for example four radial openings, and an identical number of tabs.

Furthermore, in the embodiments shown, each tab 52 includes an internal flat 58 (FIG. 4), parallel to axis 12. Each internal flat 58 forms a lateral edge of the two radial openings 50.

The rear portion 46, 246 of the clamp body 16, 216 will be described later. As will be explained below, the rear portion 46, 246 of the clamp body is mobile along an axis relative to the main body 14, 214 and blocked against rotation in the main body.

The set of clamp elements 18 is positioned in the front portion 44 of the clamp body 16, 216. More precisely, each clamp element 18 is located opposite one of the radial openings 50 of the clamp body with respect to axis 12.

Each clamp element 18 has a substantially flat rear surface 60, perpendicular to the axis 12 and facing the rear portion 46, 246 of the clamp body 16, 216. Preferably, each clamp element 18 also has a substantially flat front surface 62, parallel to and opposite the rear surface 60.

In addition, each clamp element 18 comprises a radial outer surface 64 and a radial inner surface 66, radially delimiting the clamp element with respect to the axis 12. The radial outer surface 64 comprises a groove portion 68, extending perpendicularly to axis 12, substantially equidistant from the rear 60 and front 62 surfaces. Preferably, the groove portion 68 has a circular arc shape.

Preferably, the outer radial surface 64 and the inner radial surface 66 have convex and concave shapes respectively around axis 12. Preferably, the outer radial surface 64 is included in an enveloping surface of circular-cylindrical shape, with a diameter less than or equal to that of the radial surface 48 of the front portion 44 of the clamp body.

In addition, each clamp element 18 is bounded at an angle to the axis 12 by two sides 70. Each side 70 extends in a plane passing through axis 12.

In the embodiments shown, the fastener 10, 210 comprises two clamp elements 18; and the two sides 70 of each of the clamp elements 18 are coplanar.

Furthermore, in the embodiments shown, each clamp element 18 comprises two external flats 72, parallel to each other and to the axis 12. Each external flat 72 projects radially from the groove portion 68. Each external flat 72 is adjacent to and perpendicular to one of the sides 70.

In a variant not shown, the fastener has a number of clamp elements 18 greater than or equal to three, for example four clamp elements, and an identical number of radial openings 50.

As will be explained below, each clamp element 18 is movable relative to the clamp body 16, 216, between a retracted position and a deployed position. FIGS. 2 and 5 show the retracted position of clamp elements 18. FIGS. 3 and 6 show the deployed position of clamp elements 18.

In the retracted position, the clamp element 18 is entirely contained within the radial surface 48 of the front portion 44 of the clamp body. More precisely, in the retracted position, the clamp element 18 is set back from the radial opening 50, which it is positioned opposite.

Preferably, in the retracted position, the adjacent sides 70 of two adjacent clamp elements 18 are in contact with each other and the groove portions 68 of the clamp elements form a continuous groove. In the embodiments shown, in the retracted position, the two clamp elements 18 are in contact with each other via their coplanar flanks 70, and the two groove portions 68 form a continuous groove.

In the deployed position, the clamp element 18 is positioned in the corresponding radial opening 50 and the rear surface 60 of the clamp element 18 projects radially from the radial surface 48 of the front portion 44 of the clamp body.

Preferably, in the deployed position, the rear 60 and front 62 surfaces of the clamp element 18 are in contact, respectively, with the rear 56 and front 54 edges of the corresponding radial opening 50.

In the embodiments shown, in the deployed position, each of the external flats 72 of the clamp element 18 is also in contact with the internal flat 58 of one of the two tabs 52 delimiting the corresponding radial opening 50.

The annular spring component 20 extends substantially in a plane perpendicular to axis 12 and is positioned around clamp elements 18, in contact with them.

Under mechanical stress, the annular spring component 20 is reversibly stretchable between first transverse dimension 74 (FIG. 5) and second transverse dimension 75 (FIG. 6), the second transverse dimension being strictly greater than the first transverse dimension. By “transverse dimension” we mean a maximum dimension of the annular spring component 20, measured perpendicular to axis 12.

In the retracted position of the clamp elements 18, the annular spring component 20 has the first transverse dimension 74, corresponding to a low mechanical stress. In the deployed position of the clamp elements 18, the annular spring component 20 has the second transverse dimension 75, corresponding to a higher mechanical stress.

Preferably, as in the embodiments shown, the annular spring component 20 has a substantially toroidal shape and is positioned in the groove portions 68 of the clamp elements 18. Preferably, the annular spring component 20 is a steel spring or an O-ring.

The spreader 22, 222 extends along axis 12 in the main body 14, 214 and in the clamp body 16, 216.

As will be explained below, the clamp body 16, 216 and the spreader 22, 222 are mobile along an axis relative to each other, between a first and a second axial position of the spreader 22, 222 relative to the clamp body 16, 216. FIGS. 2 and 4 show the first axial position of the spreader 22, 222 relative to the clamp body 16, 216.

More precisely, as will be explained below, the fastener 10, 210 is configured so that, when the spreader 22, 222 is in the first axial position relative to the clamp body 16, 216, the clamp elements 18 are in the retracted position; and when the spreader 22, 222 is in the second axial position relative to the clamp body 16, 216, the clamp elements 18 surround the spreader 22, 222 and are in the deployed position.

In the embodiments shown, the spreader 22, 222 has a front part 76 and a rear part 77, aligned along axis 12. The front part 76 and the rear part 77 have a first and a second radial dimension, respectively, the first radial dimension being strictly smaller than the second.

The fastener 10, 210 is configured so that, in the first axial position of the spreader 22, 222 relative to the clamp body 16, 216, the clamp elements 18 are positioned around the front portion 76 of the spreader 22, 222; and in the second axial position of the spreader 22, 222 relative to the clamp body 16, 216, the clamp elements 18 are positioned around the rear portion 77 of the spreader 22, 222.

More precisely, in the embodiments shown, each of the front 76 and rear 77 parts has a substantially circular-cylindrical shape, the rear 77 part preferably having a shape complementary to the inner radial surface 66 of each clamp element 18. Preferably, the spreader 22, 222 also comprises a tapered junction 78, connecting the front part 76 and the rear part 77. More preferably, each clamp element 18 comprises a chamfered surface 79 substantially complementary to the tapered junction 78; and in the first axial position of the spreader 22, 222 relative to the clamp body 16, 216, the chamfered surface 79 of each clamp element 18 faces the tapered junction 78 of the spreader 22, 222, as seen in FIGS. 2 and 4.

The actuating element 24, 224 is positioned in the main body 14, 214 and comprises a rear portion 80, 280 and a front portion 82, 282, aligned along the axis 12. The front portion 82, 282 of the actuating element 24, 224 will be described later.

The rear portion 80, 280 of the actuating element 24, 224 comprises a rear stop 84, 284 and a drive component 86, 286. The rear stop 84, 284 is substantially flat, perpendicular to axis 12 and oriented toward the rear. The drive component 86, 286 forms a rear projection with respect to the rear stop 84, 284. Preferably, the drive component 86, 286 also forms a rear projection from the open rear end of the main body 14, 214.

The actuating element 24, 224 is rotatable around axis 12 relative to the main body 14, 214. Preferably, the drive component 86, 286 comprises a system for rotating relative to the main body. In the embodiments shown, the drive system comprises an axial recess 88, formed by an inner wall of the drive component 86, 286. In a variant not shown, the drive system is formed on an outer wall of the drive component.

As will be explained below, the fastener 10, 210 is configured so that, under the effect of a rotation of the actuating element 24, 224 relative to the main body 14, 214, the clamp body 16, 216 and the spreader 22, 222 move relative to each other, between the first and second axial positions of the spreader 22, 222 relative to the clamp body 16, 216.

Preferably, the actuating element 24, 224 is configured to move axially relative to the main body 14, 214 over a limited stroke, between a rearward position and a forward position. More preferably, in the rear position of the actuating element, the rear stop 84, 284 is in contact with a rear wall 90 that forms a counter-stop, 290 integral with the rear end of the main body 14, 214; and the fastener 10, 210 further comprises a compression seal 92, 292, positioned in the main body 14, 214, the actuating element 24, 224 in the front position coming into contact with the compression seal 92, 292.

As will be detailed below, the fastener 10, 210 is movable between a retracted and a deployed configuration. In the retracted configuration of the fastener 10, 210, the spreader 22, 222 is in the first axial position relative to the clamp body 16, 216; each clamp element 18 is in the retracted position; and the annular spring component 20 has the first transverse dimension 74. In the deployed configuration of the fastener 10, 210, the spreader 22, 222 is in the second axial position relative to the clamp body 16, 216; each clamp element 18 is in the deployed position; and the annular spring component 20 has the second transverse dimension. FIGS. 2 and 5 show the retracted configuration of the fastener 10, 210. FIGS. 3 and 6 show the deployed configuration of the fastener 10, 210.

Preferably, in the retracted configuration of the fastener 10, 210, the actuating element 24, 224 is in a rearward position relative to the main body 14, 214.

The fastener 10 shown in FIGS. 1 to 3 will now be described in more detail.

The tubular part 30 of the main body 14 of fastener 10 has the rear wall 90, which is substantially perpendicular to axis 12. The rear wall 90 forms the counter-stop described above, integral with the rear end of the main body 14. The rear wall 90 has a central hole positioned around axis 12.

The rear inner surface 36 of the main body 14, formed by the tubular portion 30, extends axially from the rear wall 90 to a front edge 94. The front edge 94 forms a flat surface that is perpendicular to the axis 12 and faces forward.

The tubular part 30 further comprises at least two lugs 96 projecting axially from the front edge 94 of the rear inner surface 36, the lugs 96 forming the front inner surface 38 of the main body 14. Each lug 96 has a flat inner surface 98 parallel to the axis 12. The inner edges 98 form the anti-rotation form of the front inner surface 38.

In the embodiment shown, the tubular part 30 has four lugs 96, with each inner side 98 perpendicular to the angularly adjacent inner sides.

In the embodiment shown in FIGS. 1 to 3, the bearing wall 32 of the main body 14 is formed by an end cap 99, integral with the tubular part 30. The tubular part 30 and end cap 99 are assembled in a removable manner, for example using a threading/tapping system.

The retaining element 26 of the fastener 10 is positioned in the main body 14 and extends along the axis 12. The retaining element 26 is fixed in translation and rotation relative to the main body.

More specifically, the retaining element 26 comprises: a base 100; two posts 102; and a junction piece 104.

The base 100 comprises: a front face 106 and a rear face, substantially flat and perpendicular to axis 12; a through-hole 108, centered on axis 12; and an outer edge 110. The outer edge 110 has outer sides complementary to the inner sides 98 formed by the lugs 96 of the tubular part 30 of the main body 14. Posts 102 extend axially from the rear face of base 100, on either side of through-hole 108. Each post 102 comprises a flat surface 112, parallel to axis 12 and oriented towards the axis 12. The junction piece 104 joins the posts 102 to each other on the side opposite the base 100.

In fastener 10, the rear face of base 100 contacts the front edge 94 of the rear inner surface 36 of main body 14; the front face 106 of the base abuts end cap 99; and the outer edge 110 of the base bears against the inner faces 98 of the lugs 96 of tubular part 30. The base 100 of the retaining element 26 is thus held fixed in translation and rotation relative to the main body 14.

Furthermore, in fastener 10 in FIGS. 1 to 3, the spreader 22 is fixed relative to the main body 14. Preferably, the spreader 22 is attached to the retaining element 26.

More specifically, in the embodiment shown, the spreader 22 is attached to the junction piece 104 of the retaining element 26 and extends axially between the posts 102 and through the through-hole 108 of the base 100. Preferably, spreader 22 is screwed to junction 104.

In fastener 10 shown in FIGS. 1 to 3, the drive component 86 of the rear portion 80 of the actuating element 24 is positioned in the hole in the rear wall 90 of the main body 14.

The front portion 82 of the actuating element 24 is tubular in shape and includes a tapping 114. The front portion 82 is positioned around the posts 102 of the retaining element 26. Preferably, an outer surface of the front portion 82 of the actuating element 24 is circular-cylindrical, substantially complementary to the rear inner surface 36 of the main body 14.

Furthermore, in the embodiment shown, the compression seal 92 is in the form of a ring, positioned around the posts 102 and in contact with the rear face of the base 100 of the retaining element 26. The front portion 82 of the actuating element 24 is able to come into axial abutment against the compression seal 92 in the front position of the actuating element.

The rear portion 46 of the clamp body 16 of the fastener 10 will now be described.

A radial surface of the rear portion 46 comprises: two threaded areas 116, positioned opposite each other with respect to axis 12; and two flats 118, parallel to axis 12 and positioned opposite each other with respect to axis 12. The threaded areas 116 are able to cooperate with the tapping 114 of the front portion 82 of the actuating element 24. Each flat 118 is able to slide axially against the flat surface 112 of a post 102 of the retaining element 26 during rotation of the actuating element 24 relative to the main body 14. In this way, the rear portion 46 of the clamp body 16 is mobile along an axis relative to the main body 14 and blocked against rotation in the main body.

Fastener 210 shown in FIGS. 4 to 6 will now be described in more detail.

The main body 214 of fastener 210 is shown in cross-section in FIG. 3. The tubular part 230 of the main body 214 has an internal groove in the rear inner surface 236. Fastener 210 also includes a snap ring 290 housed in the internal groove. The snap ring 290 forms the counter-stop described above, integral to the rear end of the main body 214.

The rear inner surface 236 is circular-cylindrical and extends axially between the inner groove housing the snap ring 290 and a rearward-facing shoulder 120.

The front inner surface 238 of the main body 214, formed by the tubular portion 230, extends forward from the shoulder 120 and has an anti-rotation form. In the embodiment shown, the front inner surface 238 is formed by sides 122 parallel to axis 12 and has a hexagonal cross-section.

In the embodiment shown in FIGS. 4 to 6, the support wall 32 of the main body 214 is fixed relative to the tubular part 230. For example, tubular part 230 and bearing wall 32 are swaged together.

In addition, the spreader 222 of the fastener 210 is integral with the actuating element 224. In the embodiment shown, the spreader 222 is formed in one piece with the actuating element 224.

More precisely, the rear part 280 of the actuating element 224 comprises a crown 124, forming the rear stop 284. The crown 124 comprises an outer edge substantially complementary in form to the rear inner surface 236 of the main body 214. The front portion 282 of the actuating element 224 is substantially shaft-shaped and extends axially between the crown 124 and the rear part 77 of the spreader 222. The front portion 282 has a thread 126.

Furthermore, in the embodiment shown, the compression seal 292 is formed by a washer in contact with the shoulder 120 of the main body 214. The crown 124 is able to come into contact with the compression seal 292 in the forward position of the actuating element 224.

The rear portion 246 of the clamp body 216 will now be described.

An outer radial surface 128 of the rear portion 246 has an anti-rotation form, complementary to the anti-rotation form of the front inner surface 238 of the main body 214. In the embodiment shown, the outer radial surface 128 of the clamp body 216 has a hexagonal shape. The outer radial surface 128 is able to slide axially against the sides 122 of the front inner surface 238.

In addition, a radial inner surface of the rear portion 246 includes a tapping 130, able to cooperate with the thread 126 of the front portion 282 of the actuating element 224.

In this way, the rear portion 246 of the clamp body 216 can move along an axis relative to the main body 214 and is blocked against rotation in the main body.

A method for installing the fastener 10, 210 in structures 300, shown in FIGS. 3 and 6, will now be described. The structures 300 comprise a first 302 face and a second 304 face that are substantially parallel and opposite. A hole 306 in the structures 300 opens onto each of the first 302 and second 304 faces.

At the start of the installation process, fastener 10, 210 is in the retracted configuration described above.

Fastener 10, 210 is assembled to an installation tool, manual or robotic (not shown). The robot or operator inserts the clamp body 16, 216 into the hole 306 of the structures 300, until the front face 40 of the support wall 32 of the main body 14, 214 comes into contact with the first face 302.

Next, the main body 14, 214 is held fixed in rotation relative to the structures 300 by the placement tool, in particular by means of teeth 34 formed on the outer surface of the main body. At the same time, the actuating element 24, 224 is rotated around axis 12 relative to the main body, in particular by means of the axial recess 88 to which the placement tool is coupled.

In the embodiment shown in FIGS. 4 to 6, the spreader 222 is driven in rotation by the actuating element 224.

The rotation of the actuating element causes the rear portion 46, 246 of the clamp body 16, 216 to be driven axially towards the rear relative to the main body 14, 214. The movement of the rear portion 46, 246 is guided. In the embodiment shown in FIGS. 1 to 3, guidance is achieved by sliding the flats 118 of the rear portion 46 against the flat surfaces 112 of the posts 102 of the retaining element 26. In the embodiment shown in FIGS. 4 to 6, guidance is achieved by sliding the outer radial surface 128 of the rear portion 246 against the sides 122 of the front inner surface 238 of the main body 214.

Due to the axial displacement of clamp body 16 and 216, the clamp elements 18 slide backward against the tapered junction 78. As a result, the clamp elements 18 move radially away from each other and the annular spring component 20 stretches. In addition, each clamp element 18 moves outward from the corresponding radial opening 50.

As the clamp element 18 moves in the radial opening 50, the rear 60 and front 62 surfaces of the clamp element 18 slide against the rear 56 and front 54 edges, respectively, of the radial opening 50. Furthermore, in the embodiments shown, each of the external flats 72 of the clamp element 18 slides against the internal flat 58 of one of the two tabs 52 delimiting the radial opening 50.

The clamp elements 18 then reach the rear part 77 of the spreader 22, 222 and are in the deployed position. The rear surface 60 of each clamp element 18 then projects radially from the radial surface 48 of the clamp body, and the annular spring component 20 has the second transverse dimension.

The clamp body 16, 216 continues to move axially relative to the main body 14, 214. The inner radial surfaces 66 of the clamp elements 18 slide against the rear part 77 of the spreader 22, 222, until the rear surfaces 60 of the clamp elements come into contact with the second face 304 of the structures 300.

The rotation of the actuating element 24, 224 is continued until an axial compressive force is applied to the structures 300. The actuating element 24, 224 then moves axially away from the abutment 90, 290 and towards the compression joint 92, 292. A tightening torque is exerted between the threaded areas 116 of the clamp body 16 and the tapping 114 of the actuating element 24, or between the thread 126 of the actuating element 224 and the tapping 130 of the clamp body 216, resulting in an axial force exerted by the fastener 10, 210 on the structures 300.

The assembly 500 shown in FIG. 3 and the assembly 600 shown in FIG. 6 are thus obtained. The bearing wall 32 of the main body 14, 214, and the rear surface 60 of the clamp elements 18 of the fastener 10, 210, bear against the first face 302 and the second face 304 of the structures 300, respectively.

Disassembly of the assembly 500, 600 is carried out by rotating the actuating element in the opposite direction, to return the fastener 10, 210 to the retracted configuration. The clamp elements 18 then move axially along the tapered junction 78 of the spreader 22, 222, to the front portion 76 of the spreader. During this movement, the annular elastic component 20 relaxes and its transverse dimension decreases. The clamp elements 18 are then brought back inside the front portion 44 of the clamp body 16, 216.

The fastener 10, 210 can therefore be separated from the structures 300 and reused.

1. A fastener for the temporary assembly of at least two previously perforated structures, the fastener comprising:
a tubular main body extending along an axis between a front end and a rear end;
a tubular clamp body axially movable relative to the tubular main body and including a front portion and a rear portion aligned along the axis, the rear portion being blocked from rotation in the tubular main body, and the front portion forming a projection from the front end of the tubular main body, a substantially circular radial surface and a set of radial openings positioned around the axis;
a spreader extending along the axis in the tubular main body and in the clamp body; and
an actuating element positioned at the rear end of the tubular main body and rotatable relative to the tubular main body;
a set of clamp elements, each clamp element facing one of the radial openings of the clamp body, including a bearing surface substantially perpendicular to the axis and oriented towards the rear portion of the clamp body, and being movable relative to the clamp body between a retracted position, in which the clamp element is entirely contained within the radial surface of the front portion, and an extended position, in which the clamp element is positioned in the corresponding radial opening and the bearing surface projects radially from the radial surface of the front portion; and
an annular spring component, reversibly stretchable between first and second (75) transverse dimensions, surrounding the clamp elements;
wherein
the clamp body and the spreader are configured such that at least one of the clamp body and the spreader moves relative to the other of the clamp body and the spreader in response to rotation of the actuating element relative to the main body; and
the spreader is movable between a first axial position relative to the clamp body where each clamp element is in the retracted position and the annular spring component has the first transverse dimension and a second axial position relative to the clamp body where the clamp elements surround the spreader, each clamp element is in the deployed position, and the annular spring component has the second transverse dimension.

2. A fastener according to claim 1, wherein
the spreader comprises first and second parts, aligned along the axis and having first and second radial dimensions respectively, the first radial dimension being smaller than the second radial dimension; and
the clamp elements are positioned around the first part of the spreader in the retracted position and are positioned around the second part of the spreader in the deployed position.

3. A fastener according to claim 1, wherein
each clamp element comprises an outer radial surface with a groove portion substantially perpendicular to the axis; and
the annular spring component is positioned in the groove portion of each of the clamp elements.

4. A fastener according to claim 1, wherein
each clamp element is bound angularly by two sides; and
in the retracted position, the sides of two adjacent clamp elements are in contact with one another.

5. A fastener according to claim 1, wherein
the set of clamp elements comprises two clamp elements;
the clamp body comprises two radial openings and two tabs separating the radial openings and each tab comprises an internal flat that is parallel to the axis;
each clamp element comprises two external flats that are parallel to each other and to the axis; and
in the deployed position, each of the external flats of each clamp element is in contact with the internal flat of one of the two tabs.

6. A fastener according to claim 1, wherein
the spreader is axially fixed relative to the tubular main body;
the actuating element comprises a tapped internal surface; and
the rear portion of the clamp body comprises a thread, adapted to cooperate with the tapped internal surface, so that rotation of the actuating element relative to the tubular main body leads to axial displacement of the clamp body relative to the main body.

7. A fastener according to claim 6, further comprising:
a retaining element, integral with the spreader, positioned in the tubular main body and fixed relative to the tubular main body.

8. A fastener according to claim 7, wherein
the rear portion of the clamp body and the retaining element respectively comprise first and second flat surfaces, parallel to the axis; and
the first and second flat surfaces are configured to slide against one another during axial displacement of the clamp body relative to the tubular main body.

9. A fastener according to claim 1,
the spreader is integral with the actuating element;
the actuating element comprises a threaded external surface; and
the rear portion of the clamp body comprises an internal thread, configured to cooperate with the threaded external surface, so that rotation of the actuating element relative to the tubular main body leads to axial displacement of the clamp body relative to the main body.

10. A fastener according to claim 9, wherein
the rear portion of the clamp body and an inner surface of the tubular main body respectively comprise third and fourth flat surfaces, which are parallel to the axis and are able to slide against each other during axial displacement of the clamp body relative to the tubular main body.

11. A fastener according to claim 1, wherein
the tubular main body comprises a bearing wall configured to bear against a first face of the structures.

12. An assembly, comprising:
structures including first and second opposing faces, and a hole opening onto each of the first and second faces; and
a fastener according to claim 11 with the front portion of the clamp body being positioned in the hole, the bearing wall of the tubular main body and the bearing surface of the clamp elements bearing, respectively, against the first face and against the second face of the structures.
